(19) United States
(12) Patent Application Publication
(10) Pub. No.: US 2014/0084018 A1
(43) Pub. Date: Mar. 27, 2014

(54) Annular Seal, And Mold For Manufacturing Such A Seal

(71) Applicant: Le Joint Francais SNC, Paris (FR)

(72) Inventors: Mickael Onillon, Saint Malo Du Bois (FR); Christophe Lemiere, La Membrolle Sur Longuenee (FR); Joseph Cheynet, Chateau-Gontier (FR); Etienne Giffard, Ampoigne (FR)

(21) Appl. No.: 14/032,404

(22) Filed: Sep. 20, 2013

(30) Foreign Application Priority Data
Sep. 26, 2012 (FR) 12 59053

(51) Int. Cl. B65D 83/04; F16J 15/34; B29C 33/42; F16J 15/02

(52) U.S. Cl. CPC B65D 83/0409; F16J 15/02; F16J 15/34; B29C 33/42
USPC 221/1; 277/590; 425/470; 277/500; 221/9

(57) ABSTRACT

An annular seal is provided. The annular seal is configured to be lubricated, allowing for automatic dispensing in dispensers, without the risk of clogging the dispensers or of building up with other seals. The annular seal has a determined thickness, made of an elastically deformable material, having a seal plane at mid-thickness and an axis of revolution perpendicular to the seal plane, and having: a so-called “inner” surface, turned toward the axis of revolution, and extending over a height of between ⅙ and 22/50 of the thickness on either side of the seal plane, and a so-called “contact” surface extending over the rest of the seal. The seal includes, on the contact surface, at least one spot protuberance.

### FIELD

The invention relates to an annular seal, such as an O-ring seal, and a mold for manufacturing such a seal.

### BACKGROUND

Annular seals and, in particular O-ring seals, are used in very many applications. They come in all sizes.

As FIG. 1 shows, the annular seals are characterized by a profile consisting of two longitudinal planar faces on either side of the seal plane P, linked by two curved or planar transversal edges. In cross section, the annular seals have solid parts and openwork parts. For example, for a conventional O-ring seal, the solid parts have a circular cross section. There are many forms of annular seals, for example, clover-leaf seals or so-called “D” seals, in which the solid parts have a cross section in the form of a D turned inward or outward depending on the application of the seal.

For some applications, the annular seals are delivered lubricated. This makes it possible to reduce the efforts in assembling the seal when it is being mounted.

Generally, in industry, the annular seals, lubricated or not, are delivered in bulk and then are dispensed to the users and to the automatic assembly machines by automated systems of vibratory hopper feeder or vibrating rail types.

In practice, it is found that the seals adhere to the walls of the dispenser and/or stick together, which slows down their dispensing. This is illustrated in FIG. 2 which is a photograph of a dispenser D of conventional O-ring seals J in which the seals are stuck together in batches P.

For the lubricated seals, these phenomena are due to the surface tension of the lubricant used which generates forces of capillary attraction between the seals and/or the walls of the dispenser. Furthermore, the lubricant fouls the dispensers. With time, the seals arriving in these dispensers can adhere more and more to the walls. It is then necessary to clean the dispensers very regularly.

For the non-lubricated seals, these phenomena are due to the fact that the friction between the seals and/or with the walls of the dispenser charge the seals with static electricity. The seals stick together and/or adhere to the walls of the dispenser by electrostatic attraction.

At the output of the dispenser, the user therefore sees bundles of seals arriving that have to be undone in order to be able to remove a single seal. This operation requires him to use (and therefore soil in the case of lubricated seals) both his hands, whereas ideally, the user should be able to take the seals individually in one hand. For a machine, the phenomenon is all the more problematical since the latter is stopped for the servicing personnel to be able to undo the bundles of seals and restart the machine.

The rates of assembly and the working conditions of the users are therefore affected by these problems of clogging up of the dispensers and the build up of seals.

### SUMMARY

The objective of the present invention is to propose an annular seal, that can be lubricated, allowing for automatic dispensing in the dispensers, without the risk of clogging up the dispensers or of sticking together with other seals.

To this end, the invention proposes providing the surface of the seal with spot protuberances (that is to say, non-annular and having a footprint on the seal that is negligible relative to the total surface of the seal, that is to say less than or equal to 1%).

To this end, the subject of the invention is an annular seal, made of an elastically deformable material, comprising a seal plane at mid-thickness and an axis of revolution perpendicular to the seal plane, and having:
a so-called “inner” surface turned toward the axis of revolution, and extending over a height of between ⅙ and 22/50 of the thickness on either side of the seal plane, and
a so-called “contact” surface extending over the rest of the seal, characterized in that it comprises, on the contact surface, at least one spot protuberance.

According to other embodiments:
the inner surface may extend over a height of preferably between ⅕ and ⅖ of the thickness on either side of the seal plane, advantageously between ⅓ and ⅖ of the thickness on either side of the seal plane;
said at least one protuberance may have a height of between 0.2% and 15% of the thickness of the seal, preferably between 0.3% and 10% of the thickness of the seal, advantageously between 0.5% and 5% of the thickness of the seal, typically between 1% and 3% of the thickness of the seal;
the contact surface may have at least three spot protuberances on either side of the seal plane axis;
the spot protuberances may protrude relative to the seal seen in projection orthogonal to the seal plane;
the contact surface may comprise three areas:
a so-called “outer” area opposite the inner surface relative to the seal, and extending over a height of between ⅙ and 22/50 of the thickness of the seal on either side of the seal plane, preferably between ⅕ and ⅖ of the thickness on either side of the seal plane, advantageously between ⅓ and ⅖ of the thickness on either side of the seal plane;
two so-called “lateral” areas situated on either side of the seal plane and each extending between the outer area and the inner surface,
the protuberance or protuberances being situated on the lateral areas;
the protuberances may be arranged perpendicularly to the seal plane;
the inner surface and the contact surface may be lubricated;
the spot protuberances may have a shape chosen from the hemispherical, pyramidal, conical, tapered or polyhedral shapes; and/or
the annular seal may have a symmetry relative to the seal plane.

The invention also relates to a mold for manufacturing a seal comprising a seal plane at mid-thickness and an axis of revolution perpendicular to the seal plane, and having:
a so-called “inner” surface, turned toward the axis of revolution, and extending over a height of between ⅙ and 22/50 of the thickness on either side of the seal plane, and
a so-called “contact” surface extending over the rest of the seal, characterized in that the mold comprises at least one first and one second die, movable relative to one another, comprising at least one cavity located in such a way that, in use, at least one spot protuberance is located on the contact surface of the seal.

The invention also relates to a use of the above seals with at least one annular seal automatic dispensing machine provided with at least one automatic dispenser.

The invention also relates to a method for automatically dispensing annular seals in bulk in a machine provided with an automatic dispenser, comprising:

(a) the bulk supply of annular seals upstream of the dispenser; and

(b) the displacement of the annular seals downstream of the dispenser,

in which the step (a) consist in supplying the above annular seals.

Preferably, the dispenser is chosen from a gravity dispenser, a vibrating dispenser, a centrifugal force dispenser, a belt conveyor or a bucket conveyor.

### BRIEF DESCRIPTION OF THE DRAWINGS

Other features of the invention will emerge from the following detailed description, given with reference to the appended drawings which represent, respectively:

FIG. 1, a schematic view in projection orthogonal to the seal plane of a conventional O-ring seal;

FIG. 2, a photograph of a dispenser of conventional O-ring seals in which the seals are bunched together;

FIG. 3, a schematic view in partial cross section, orthogonal to the seal plane, of an embodiment of an O-ring seal according to the invention;

FIG. 4, a schematic view in partial cross section, orthogonal to the seal plane, illustrating different possible alternatives of an O-ring seal according to the invention;

FIG. 5, a schematic view in partial cross section, orthogonal to the seal plane, of an embodiment of a clover-leaf seal according to the invention;

FIG. 6, a schematic view in partial cross section, orthogonal to the seal plane, illustrating different possible alternatives of a clover-leaf seal according to the invention;

FIG. 7, a schematic view in partial cross section, orthogonal to the seal plane, of an embodiment of a self-maintained seal according to the invention;

FIG. 8, a schematic view in partial cross section, orthogonal to the seal plane, of an embodiment of a D-section seal according to the invention;

FIG. 9, a schematic view in perspective of an O-ring seal according to the invention;

FIG. 10, a schematic view in projection orthogonal to the seal plane, of the seal of FIG. 9 resting on a surface; and

FIG. 11, a graph illustrating the trend over time of the rate of dispensing of conventional O-ring seals and of O-ring seals according to the invention.

### DETAILED DESCRIPTION

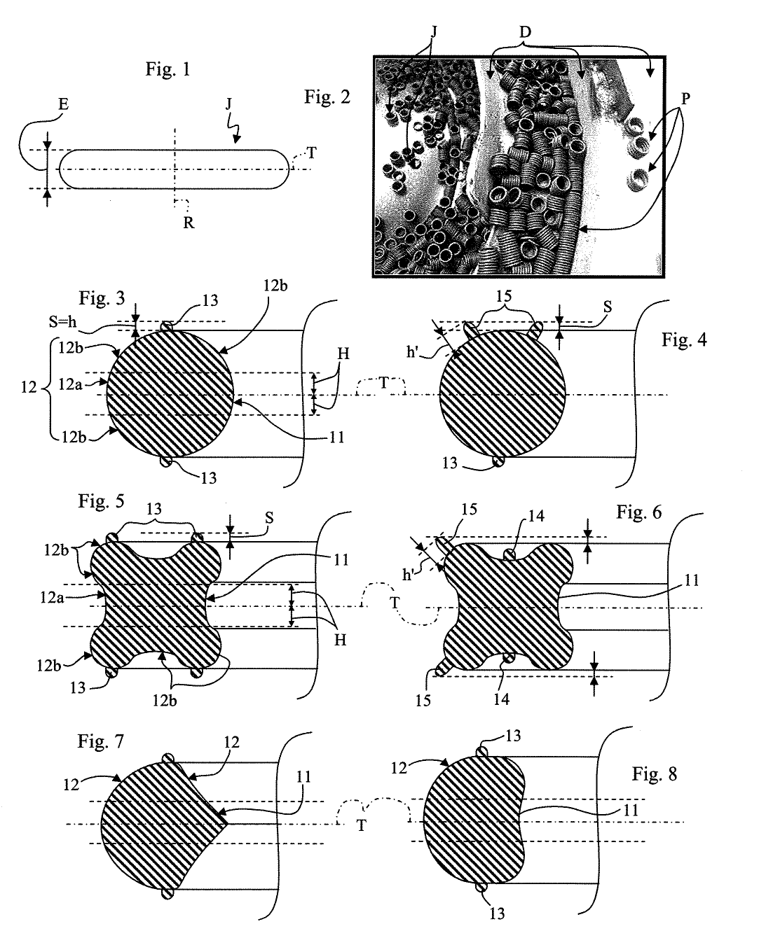

FIGS. 1 and 2 illustrate the state of the art.

A first embodiment of a seal according to the invention is illustrated in FIG. 3.

The annular seal 10 comprises a seal plane T and an axis of revolution R (not represented) perpendicular to the seal plane T. The seal 10 has a determined thickness E. The thickness E of an annular seal is measured conventionally between the two tangents to the seal parallel to the seal plane T.

The seal plane T considered is situated at mid-thickness of the seal. In other words, the maximum height of the seal measured from the seal plane is equal to E/2.

The seal 10 has:
a so-called “inner” surface 11, turned toward the axis of revolution R, and extending over a height H of between ⅙ and 22/50 of the thickness E on either side of the seal plane T, and
a so-called “contact” surface 12 extending over the rest of the seal.

In other words, the inner surface 11 extends over the part of the seal turned toward the axis of revolution R and over a total height 2H of between ⅓ (that is to say ⅙+⅙) and 44/50 (that is to say 22/50+ 22/50). The contact surface 12 therefore extends, on the one hand, over the part of the seal turned toward the axis of revolution R and over a total height 2H of between ⅓ (that is to say ½−⅙) and 3/50 (that is to say ½− 22/50), and, on the other hand, over all of the part opposite the inner surface relative to the seal.

According to the invention, the seal 10 comprises, on the contact surface 12, at least one spot protuberance 13.

The term “spot” should be understood to mean that the protuberance is not continuous or annular. It has a projected surface on the seal that is restricted relative to the total surface of the seal. This makes it possible to reduce the contact surface between seals and with the dispenser.

The spot protuberance(s) have a shape chosen from the hemispherical, pyramidal, conical, tapered or polyhedral shapes. For a hemispherical protuberance, its width is two times greater than its height.

Obviously, the spot protuberances according to the invention have absolutely nothing in common with the lips or the lobes provided on certain seals and which constitute functional parts thereof, that is to say parts involved in the sealing function of the seal.

The spot protuberance(s) 13 have a height h of between 0.2% and 15% of the thickness E of the seal 10.

The height of the protuberance depends on the material used to manufacture the seal and, where appropriate, the surface tension of the lubricant employed.

In practice, the minimum height of the seal should take into account the crushing of the seal under its own weight to avoid having the protuberances totally compressed under the simple weight of the seal. Furthermore, the protuberances have to be sufficiently high to ensure the separation of the seal from another seal and/or from the surface of the dispensers, despite the presence of lubricant. In other words, the lubricant, because of its surface tension, must not be able to occupy all the space situated between the protuberances, the contact surface of the seal and the other seal or the surface of the dispenser.

Preferably, the spot protuberance(s) 13 have a height h of between 0.3% and 10% of the thickness E of the seal, advantageously between 0.5% and 5% of the thickness E of the seal, typically between 1% and 3% of the thickness E of the seal.

Although a single protuberance 13 is sufficient to separate the seal from another seal or from the surface of the dispenser, the presence of at least three spot protuberances on either side of the seal plane T axis provides a very significant improvement to the results.

For the O-ring seals (FIGS. 3 and 4), the self-maintained seals (FIG. 7) and the D-section seals (FIG. 8), the spot protuberances are configured to protrude S relative to the seal when seen in projection orthogonal to the seal plane T. In other words, the tangent (illustrated by a dotted line in FIGS. 3, 4, 7 and 8) to the protuberances, parallel to the seal plane T, is situated at a distance S from the tangent to the contact surface of the seal, parallel to the seal plane T.

For the clover-leaf seals (FIGS. 5 and 6), the spot protuberances may also be configured to protrude S relative to the seal when seen in projection orthogonal to the seal plane T. Alternatively, or in combination, a clover-leaf seal according to the invention may comprise one or more protuberances 14 arranged between two lobes situated on the same side of the seal relative to the seal plane T.

These protuberances 14 prevent the lobes of another seal from being inserted between the lobes of the seal which bears them, without there being a need for the protuberances 14 to protrude relative to the seal when seen in projection orthogonal to the seal plane T.

To limit the quantity of material used while avoiding having the seals congregate together or stick to the walls of the dispensers, the protuberance(s) are circumscribed in localized areas.

Thus, three areas can be defined on the contact surface 12:
one area 12a, called “outer”, situated opposite the inner surface relative to the seal, and extending over a height H of between ⅙ and 22/50 of the thickness E of the seal on either side of the seal plane T, preferably between ⅕ and ⅖ of the thickness E on either side of the seal plane T, advantageously between ⅓ and ⅖ of the thickness E on either side of the seal plane T;
two areas 12b, called “lateral”, situated on either side of the seal plane T and each extending between the outer area and the inner surface.

In other words, each lateral area extends on either side of the seal plane T, over a height of between ⅓ and 3/50 of the thickness E of the seal. In other words, the lateral areas are situated at the vertices of the seal, in the top third and the bottom third in FIG. 3, the median third being occupied by the inner surface and the outer area.

The more the inner surface and the outer area are extended (up to 22/50^{th} of the thickness E), the more the lateral areas are restricted (up to 3/50^{th}) and are situated close to the tangent to the seal parallel to the seal plane T.

Preferably, the protuberances 13-14 are arranged on the lateral areas 12b.

Advantageously, the protuberances 13-14 are arranged perpendicularly relative to the seal plane T (FIGS. 3 to 8). Alternatively, or in combination, the seal 10 bears protuberances 15 forming an angle α with the seal plane T. In this case, the height h′ of the protuberances 15 is greater than the height h of the protuberances 13-14 so that they protrude S relative to the seal when seen in projection orthogonal to the seal plane T.

This makes it possible to reduce the crushing forces parallel to the axis of revolution R of the seal when it is mounted, because the protuberances can bend, while ensuring that the seals do not congregate together or stick to the wall of the dispensers.

One exemplary embodiment of an O-ring seal according to the invention is illustrated in FIG. 9. The O-ring seal 20 is made of EPDM (ethylene-propylene-diene monomer) and measures 7.65 mm in diameter, and 1.78 mm in thickness E (the thickness E is here equal to the diameter of the torus). The seal 20 has been produced with six protuberances 21 arranged perpendicularly to the seal plane T with a height H equal to E/2 (+ or −0.05 mm). In practice, each protuberance 21 is hemispherical and has a height of 0.05 mm and therefore a footprint on the seal of 0.1 mm (2*0.05 mm).

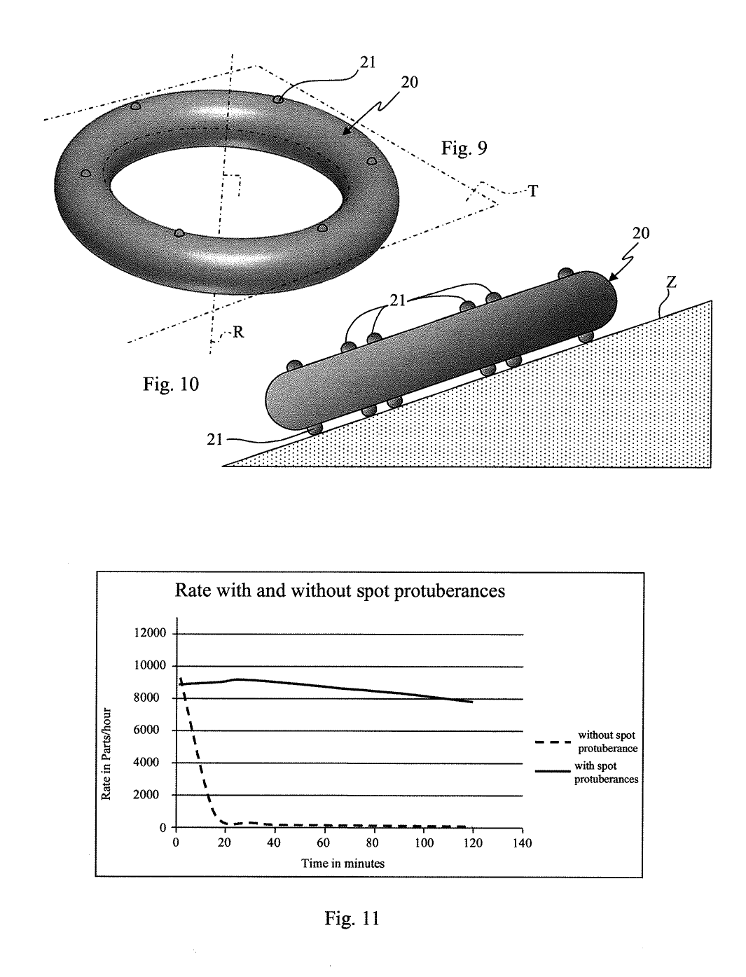

The spot protuberances 21 protrude S relative to the seal when seen in projection orthogonal to the seal plane T, so that, when this seal is placed on a flat surface Z (FIG. 10), it is in contact with this surface Z only via the spot protuberances 21.

The seal is advantageously lubricated, for example with a silicone-based oil.

Rate measurement tests have been conducted with O-ring seals according to the invention (provided with protuberances) in comparison to conventional O-ring seals (without protuberances).

The rate measurements were carried out in a dispenser consisting of a vibratory hopper feeder equipped with a metering cell at the hopper output to measure the rate at the hopper output. The rate is expressed in parts per hour.

The results are illustrated in the graph of FIG. 11.

Without protuberance (dotted line in FIG. 11), the dispensing rate degrades over time: the seals aggregate together, or stick to the dispenser, so that, in 20 minutes, the rate changes from 9,000 parts per hour to less than 100 per hour.

With the protuberances (continuous line in FIG. 11), the seals do not aggregate together and do not stick to the wall of the dispenser. The rate has not decreased after 20 minutes. After two hours of operation, the rate has decreased by only approximately 10%.

The invention therefore makes it possible to maintain the rate and limit the number of dispenser cleaning operations, thus saving on time and servicing products.

Other tests were conducted with seals made of EPDM of different sizes: 20 mm diameter and 2.62 mm thickness E.

The rate of dispensing is also improved compared to seals of the same size but without protuberance.

Thus, generally, the dispenser becomes clogged up much less quickly since the contact surface between the seals and between each seal and the dispenser is much smaller.

By having spot protuberances on the surface of the seal, the invention therefore runs counter to the prejudice according to which the surface of the seal should be as smooth as possible to ensure the best possible seal-tightness. In practice, the molds conventionally used are as smooth as possible, and there are many methods aimed at eliminating any accidental or inevitable imperfection deriving from the molding, such as seal plane burrs.

Contrary to this practice, the invention provides for the mold for manufacturing the seal to include at least one first and one second die, movable relative to one another, comprising at least one cavity located such that, in use, at least one spot protuberance is located on the contact surface of the seal.

Advantageously, the cavity or cavities are located in the lateral areas of the seal.

Despite the presence of the spot protuberances, the seals according to the invention ensure their primary sealing function.

According to other features of the invention, the annular seal may or may not have a symmetry relative to the seal plane T.

The invention also relates to the use of seals described previously and provided with spot protuberances on the contact surface, with an automatic annular seal dispensing machine provided with at least one automatic dispenser of toboggan, vibratory hopper feeder, vibrating rail, centrifuge hopper, belt conveyor or bucket conveyor type.

More generally, the dispenser is a gravity dispenser, a vibrating dispenser, a centrifugal force dispenser or a mechanical conveyor (belt or bucket type).

These types of machines are, for example, sold by the companies BERNAY AUTOMATION, CERMA′C or TECHNIMODERN AUTOMATION.

The invention also relates to a method for automatically dispensing annular seals in bulk implemented in a machine provided with an automatic dispenser, comprising:

(a) the bulk supply of annular seals upstream of the dispenser; and

(b) the displacement of the annular seals downstream of the dispenser,

the step (a) consisting in supplying annular seals according to the invention.

By virtue of the seal according to the invention, the dispensing is easier because the seals aggregate together much less and adhere almost not at all to the dispenser.

The rates of mounting of the seals are accelerated because it is no longer necessary to stop the assembly robots to separate the bundles of seals.

1. Annular seal of thickness (E), made of an elastically deformable material, comprising a seal plane at mid-thickness and an axis of revolution perpendicular to the seal plane, and having:
a so-called “inner” surface turned toward the axis of revolution, and extending over a height (H) of between ⅙ and 22/50 of the thickness (E) on either side of the seal plane (T), and
a so-called “contact” surface extending over the rest of the seal,
characterized in that it comprises, on the contact surface, at least one spot protuberance.

2. Annular seal according to claim 1, in which the inner surface extends over a height (H) between ⅕ and ⅖ of the thickness (E).

3. Annular seal according to claim 1, in which the inner surface extends over a height (H) between ⅓ and ⅖ of the thickness (E) on either side of the seal plane (T).

4. Annular seal according to claim 1, in which said at least one protuberance has a height (h) between 0.2% and 15% of the thickness (E) of the seal.

5. Annular seal according to claim 1, in which said at least one protuberance has a height (h) between 1% and 3% of the thickness (E) of the seal.

6. Annular seal according to claim 1, in which the contact surface has at least three spot protuberances on either side of the seal plane axis.

7. Annular seal according to claim 1, in which the spot protuberances protrude relative to the seal seen in projection orthogonal to the seal plane.

8. Annular seal according to claim 1, in which the contact surface comprises three areas:
a so-called “outer” area opposite the inner surface relative to the seal, and extending over a height of between ⅙ and 22/50 of the thickness (E) of the seal on either side of the seal plane;
two so-called “lateral” areas situated on either side of the seal plane and each extending between the outer area and the inner surface,
the protuberance or protuberances being situated on the lateral areas.

9. Annular seal according to claim 8, in which the protuberances are arranged perpendicularly to the seal plane.

10. Annular seal according to claim 1, in which the inner surface and the contact surface are lubricated.

11. Annular seal according to claim 1, in which the spot protuberances have a shape chosen from the hemispherical, pyramidal, conical, tapered or polyhedral shapes.

12. Annular seal according to claim 1, having a symmetry relative to the seal plane.

13. Mold for manufacturing a seal comprising a seal plane at mid-thickness and an axis of revolution (R) perpendicular to the seal plane, and having:
a so-called “inner” surface, turned toward the axis or revolution, and extending over a height (H) of between ⅙ and 22/50 of the thickness (E) on either side of the seal plane, and
a so-called “contact” surface extending over the rest of the seal,
characterized in that the mold comprises at least one first and one second die, movable relative to one another, comprising at least one cavity located in such a way that, in use, at least one spot protuberance is located on the contact surface of the seal.

14. Use of seals according to claim 1 with at least one annular seal automatic dispensing machine provided with at least one automatic dispenser.

15. An annular seal automatic dispensing machine comprising at least one automatic dispenser, and being configured with the annular seal of claim 1.

16. Method for automatically dispensing annular seals in bulk in a machine provided with an automatic dispenser, comprising:
(a) the bulk supply of annular seal upstream of the dispenser; and
(b) the displacement of the annular seals downstream of the dispenser,
wherein the step (a) comprises in supplying annular seals according to claim 1.

17. Automatic dispensing method according to the preceding claim 16, in which the dispenser is chosen from a gravity dispenser, a vibrating dispenser, a centrifugal force dispenser, a belt conveyor or a bucket conveyor.
